(19) United States
(12) Patent Application Publication
(10) Pub. No.: US 2014/0173503 A1
(43) Pub. Date: Jun. 19, 2014

(54) System and Method for the Obfuscation, Non-Obfuscation, and De-Obfuscation of Online Text and Images

(71) Applicant: Michael R. Catania, Tallahassee, FL (US)

(72) Inventor: Michael R. Catania, Tallahassee, FL (US)

(21) Appl. No.: 14/132,799

(22) Filed: Dec. 18, 2013

Related U.S. Application Data
(60) Provisional application No. 61/738,442, filed on Dec. 18, 2012.

(51) Int. Cl. G06F 3/0481

(52) U.S. Cl. CPC G06F 3/04812
USPC 715/781

(57) ABSTRACT

A computer program system and method for the obfuscation, semi-obfuscation, and de-obfuscation of text and images through interaction with a user. The method includes the steps of providing a set of source code which is accessible to a user through the Internet. A user accesses the webpage which loads a first user interface encoded by the set of source code. The first user interface displays at least one display box with text or image having a set of information. When the user performs an action over the display box a response is triggered: displaying a first altered display box. It the user stops performing, the action, the display box returns to its original state. If the user clicks on the first altered display box, a second response is triggered. All actions from the user are able to be tracked and recorded.

Pursuant to the provisions of 37 C.F.R. §1.53(c), this non-provisional application claims the benefit of an earlier-filed provisional patent application. The earlier application was assigned Ser. No. 61/738,442. It lists the same inventor.

### CROSS-REFERENCES TO RELATED APPLICATIONS

Not Applicable

### STATEMENT REGARDING FEDERALLY SPONSORED RESEARCH OR DEVELOPMENT Not Applicable

### MICROFICHE APPENDIX

Not Applicable

### BACKGROUND OF THE INVENTION

1. Field of the Invention

This invention relates to a computer-implemented method and system for obfuscation, semi-obfuscation. and de-obfuscation of online text and images. Specifically, the method and system allows for viewing portions of images and/or text by hovering a cursor over a display box on a webpage and revealing entire or additional images and/or text when the display box is selected or clicked.

2. Description of the Related Art

Online shopping allows users to visit a website to shop and purchase a multitude of products and services online as opposed to entering a physical location. From a user/shopper standpoint, e-commerce eliminates the hassle and time of getting to and from a store to purchase items. From a retailer standpoint, an e-commerce site is a low-cost alternative to setting up a retail location or a low-maintenance supplement to its existing physical location.

The advent of e-commerce has led to a new system and culture in which consumers and businesses operate. In the new system, marketing, selling, advertising, and purchasing differ from traditional methods. One example is the ever-increasing usage of online coupons. Online coupons often consist of a simple alphanumeric code, which is entered by a consumer upon “check out” on a website. The code permits the consumer to take advantage of discounts that the retailer offers; for example, free shipping specials or a reduction in price of the purchased products. The codes can be e-mailed to a consumers posted online by the retailer, handed out on cards at physical locations or events, or provided in advertisements on other websites. Additionally there are currently many third-party websites that offer searchable online databases for consumers to view codes relating to thousands of e-commerce websites.

A customer may begin by shopping on an e-commerce website for a particular product. Upon check-out the consumer may be prompted by the website to enter a “coupon code” to take advantage of a particular discount that the e-commerce business is offering. A consumer may search online for particular coupon or discount online. Affiliate sites offer coupon codes which the consumer can click and be linked to the e-commerce business' website. The affiliate receives a commission based on the sales made following the redirection.

It is becoming increasingly common for consumers to utilize a mobile personal computing device, such as a Smartphone or Tablet computer to access e-commerce sites, e-commerce applications and/or coupon code web-sites. However, online coupon codes, shopping cart images/text and other similar “display box” type graphics are primarily displayed using Adobe Flash®, which is owned by Adobe Systems Incorporated, headquartered in San Jose, Calif. It is desirable for these types of graphic images and/or text to create a visual intrigue to users by offering text which describes a discount or other incentive and encourages a user to click to reveal the actual coupon code to use or other image/text which is pertinent to the user. Adobe Flash® is basic and easy to use animation software which allows users to create this type of attractive animation or graphic image. However, most mobile computing devices do not fully support Adobe Flash®. Thus, in order to access the computer file, such as a graphic image or text, the mobile computing device must use separate applications or webpage renderings in order to view the image or text. Oftentimes, this increases the loading time of the images and/or changes the appearance of the image to the user.

Further, graphic images used in display boxes, such as those used to display on-line discounts or coupon codes, are often presented on a user interface that is ineffective and undesirable. Currently, a user may view a partial image of a graphic or text on the user interface. The image is not interactive when the consumer performs an action, such as a mouse over action (e.g. movies the cursor or pointer over the image). Thus, the consumer may become disinterested or may not be intrigued to click on the graphic image. Ultimately, if the consumer does not select (or click) the coupon code, the affiliate web-site offering the coupon code does not get credit with the e-commerce retailer for the consumer's use of their web-site. Moreover, the current system requires graphics or images which prevent the codes from loading properly or quickly on certain programs, browsers or devices.

Therefore what is needed is a system and method that provides a computer file, such as a graphic image or text display box that functions on all mobile devices, allows faster load time, provides a consistent and intriguing display across both mobile and desktop platforms, and permits better tracking of the user's actions.

### BRIEF SUMMARY OF THE PRESENT INVENTION

The present invention is a computer-implemented system and method for the obfuscation, semi-obfuscation, and de-obfuscation of online computer files, such as text and images, through interaction with a user. The method includes the steps of providing a set of source code to a server system, including a web server which is accessible to a user through the Internet. A user accesses the webpage through a computing device which loads a first user interface encoded by the set of source code. The first user interface displays at least one display box with a set of text or image within having a set of information or a partial set of information therein. When the user performs an action, such as moving a cursor or pointer over the display box and hovers (mouse over), a response is triggered: displaying a first altered display box. The first altered display box can be modified by expanding a border, modifying the text within or providing additional images or text. If the user moves the cursor away from the box, the display box returns to its original state. However, if the user clicks on the first altered display box, a second response is triggered and a second altered display box is shown to the user. The second altered display box may reveal a full display of information, all information embedded on a webpage (e.g. all listed coupon codes), provide additional images or text, and/or provide a link to another site or webpage. All actions from the user are able to be tracked and recorded.

### BRIEF DESCRIPTION OF THE SEVERAL VIEWS OF THE DRAWINGS

FIG. 1 is a flow chart, showing the present invention.

FIG. 2 is a diagram, showing the steps of providing the user with the online discount.

FIG. 3 is a screen shot, showing a first user interface showing a display box.

FIG. 4 is a screen shot, showing a first response from the display box.

FIG. 5 is a screen shot, showing a second user interface illustrating a second response from the display box.

FIG. 6 is a block diagram, showing an embodiment of the present invention.

REFERENCE NUMERALS IN THE DRAWINGS

| 10 | computer program product and method | | |
|---|---|---|---|
| 12 | first user interface | 14 | display box |
| 16 | first altered display box | 18 | second altered display box |
| 20 | cursor | 22 | optional second user interface |
| 24 | server system | 26 | computing device |
| 28 | browser | 30 | web page |
| 32 | server engine | 34 | first database |

| | |
|---|---|
| 36 | communications link |

### DETAILED DESCRIPTION OF INVENTION

The present method and system is a computer program product 10 for providing the obfuscation, semi-obfuscation and de-obfuscation of online text and/or images for an on-line interaction with a user via a website. FIG. l illustrates the present method in a flow chart.

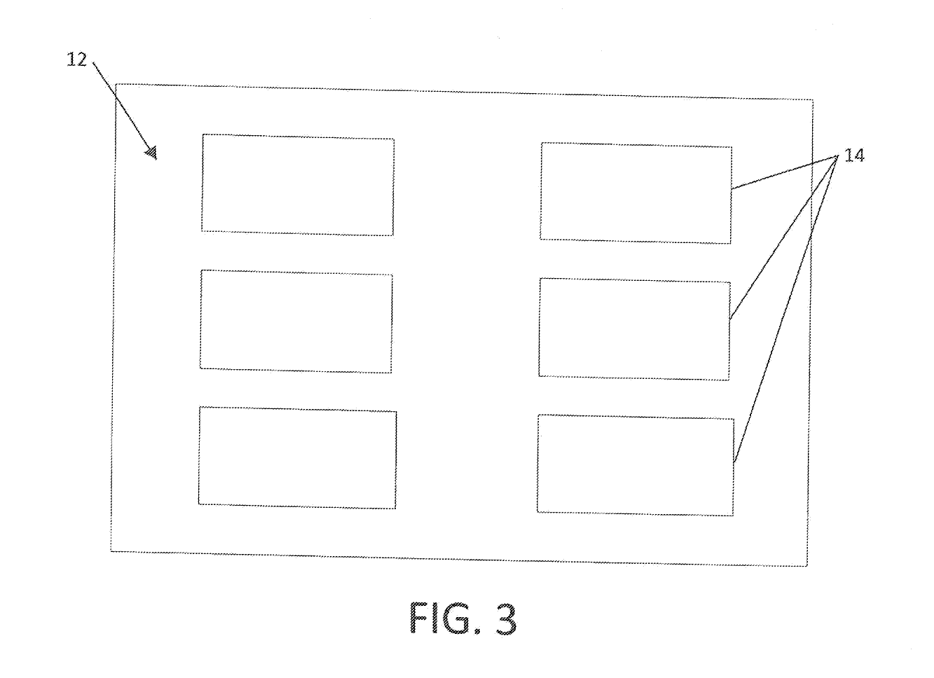

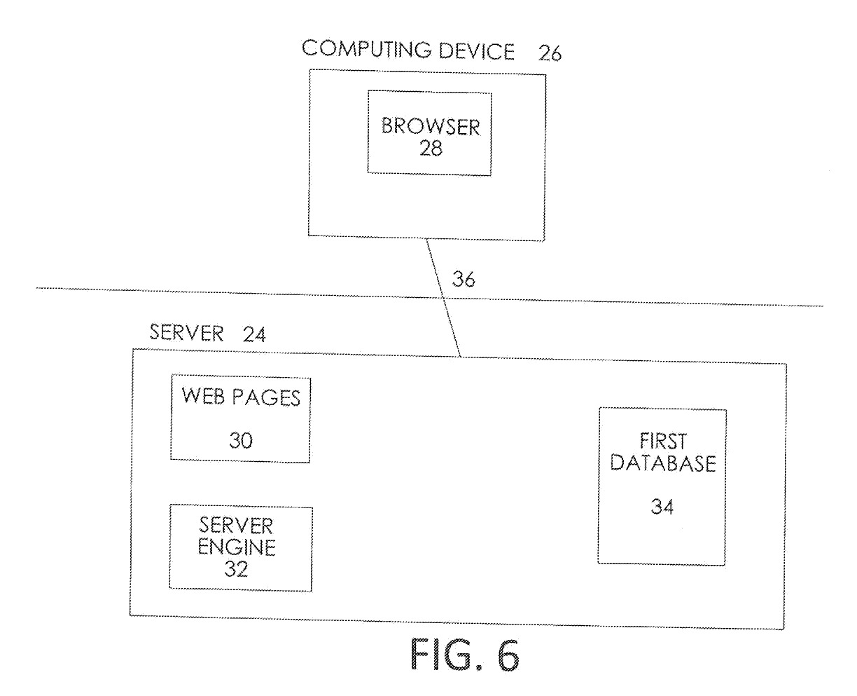

A user accesses the Internet typically via a web browser 28 on a computing device 26, as illustrated in a block diagram in FIG. 6. The computing device 26 communicates with a server system 24 via a communications link 36. The server system 24 includes webpages 30, a server engine 32 and at least one first database 34. When the user inputs a URL or Uniform Resource Locater (web address) or clicks on a link to a URL, the server engine 24 receives the request and the user interface displays the content of a particular webpage or webpages 30. A webpage 30 has a set of source code (computer readable program code) which encodes a set of instructions. This source code is generally located on server system 24 which the user accesses. The user's application displays the webpage 30 on a first use interface on the user's device 26 according to the relevant source code. In the present embodiment webpage 30 includes a computer file or display box 14 on a first user interface 12, as illustrated in FIGS. 3-5. Computer file can be a text file, image file or other file that appears as a display box 14 to the user. User can interact with the display box 14 on webpage 30 through communications link 36. A first database 34, illustrated in FIG. 6, is capable of storing the user's interaction with the webpage 30 as further described herein.

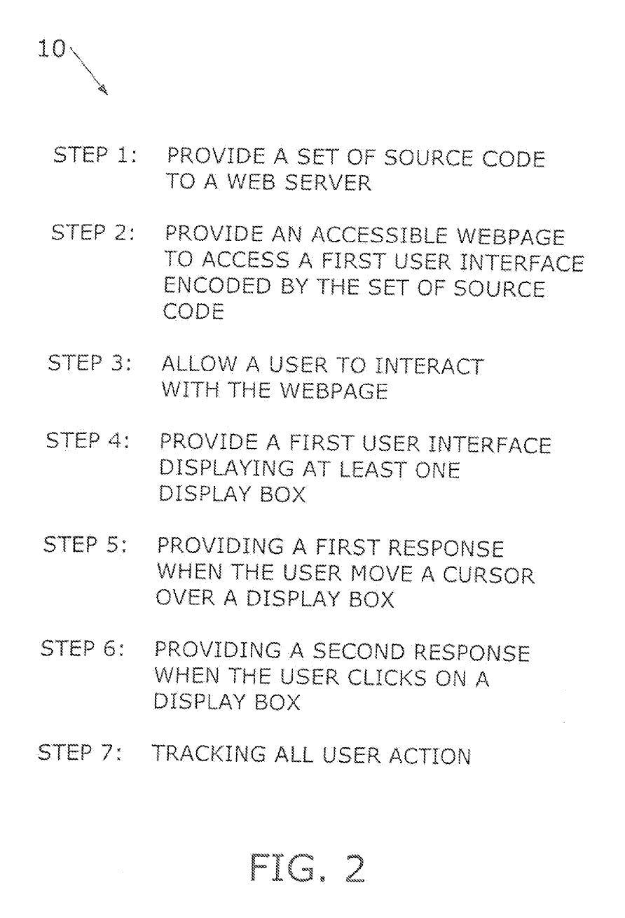

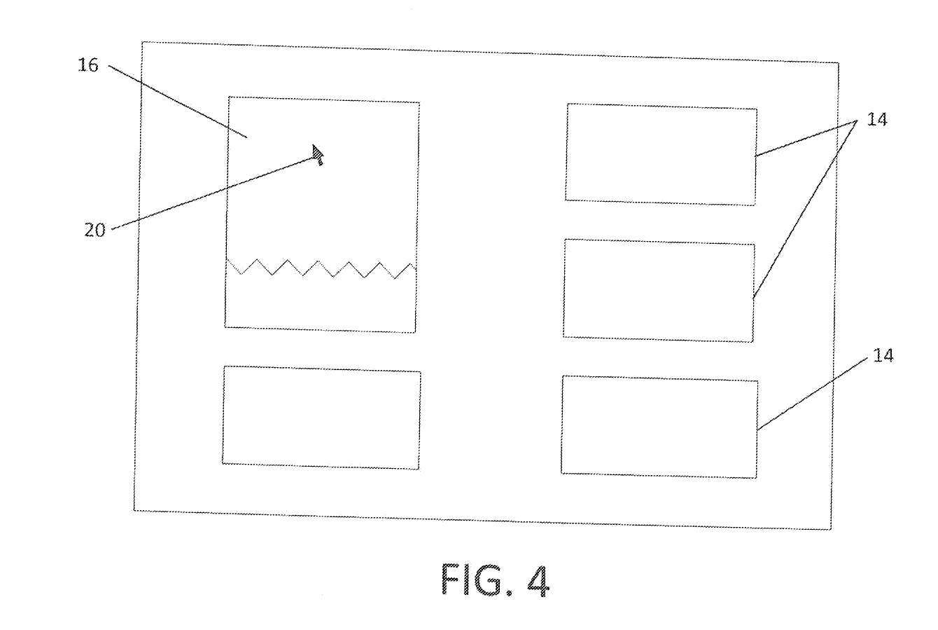

A diagram of the present computer program product and method 10 is shown in FIG. 2. The reader will appreciate that the FIGS. 3-6 illustrate the representative steps and embodiment of the present invention and should be read in conjunction with FIG. 2. A set of source code is provided to a web server which is accessible via an Internet connection by a user. A webpage is provided which displays a first user interface 12 based on the instructions of the source code, as illustrated in FIG. 3. The present method is a method for presenting a computer file in a manner which encourages users to continue to interact with the web-page. The present method can be used for any graphic image or text but is directed towards text in which the website may benefit from the user interaction. For example, a site may be an affiliate website offering an online discount code in which a commission is received for providing the discount code or link to an on-line e-commerce site where a purchase is made. The first user interface 12 provided consists of at least one display box 14 which is visible to the user. The display box 14 may include a teaser, or partial set of information. The online text or image is therefore obfuscated. When the user performs a first action, such as moving a cursor 20 over or touching the screen of user's device over the display box 14, the display box interacts with the user by providing a first response or altered display box 16, as seen in FIG. 4. A mouseover or mouse hover refers to a graphical user interface event that occurs when the user moves the cursor over a particular area on the screen or graphical user interface. The same functionality can be imitated in a touch screen device. Thus, the first response may be that the display box expands by repositioning one of its borders, adjusts styles of the text within the box or releases another image from the box, such as dollars or coins. Any known method of repositioning or responding can be provided. In this first response the graphic image or text is semi-obfuscated. The action of the user or user's mouse over the display box can be recorded or tracked by the webpage by the default javascript action or onmouseover action, which has the ability to call an external actionable script (such as one to store data about the user). This data is stored in a first database 34. Although a mouse and cursor is used as an example for interacting with display box, the present method should not be limited by the use of a mouse or existence of a cursor. For example, a user could select or “hover” over display box by holding a finger on a touch screen of the user's computing device 26.

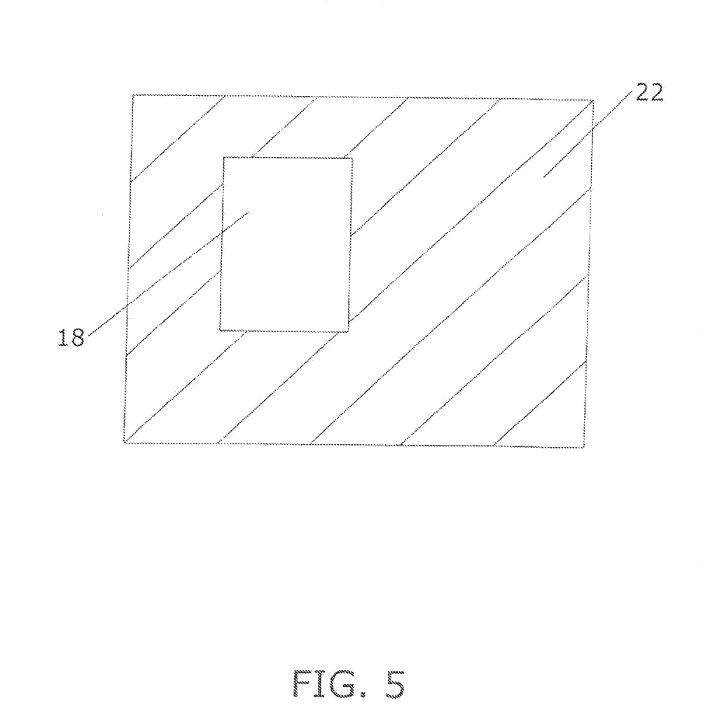

The first response, providing the semi-obfuscated text or image, encourages the user to click on the display box for a second response or second altered display box 18, illustrated in FIG. 5. The second response may be to display additional information, image or text, reposition the display box again and/or be taken to a particular linked website. In this step the online text or image is de-obfuscated. Additionally, an optional second user interface 22 can be displayed which darkens or modifies the webpage such that the other display boxes are no longer visible or are faded or a second user interface 22 can display all of the online discount codes on the particular webpage. The click by the user to provide second altered display box 18 can also be tracked by the webpage by default javascript action or onmouseover.

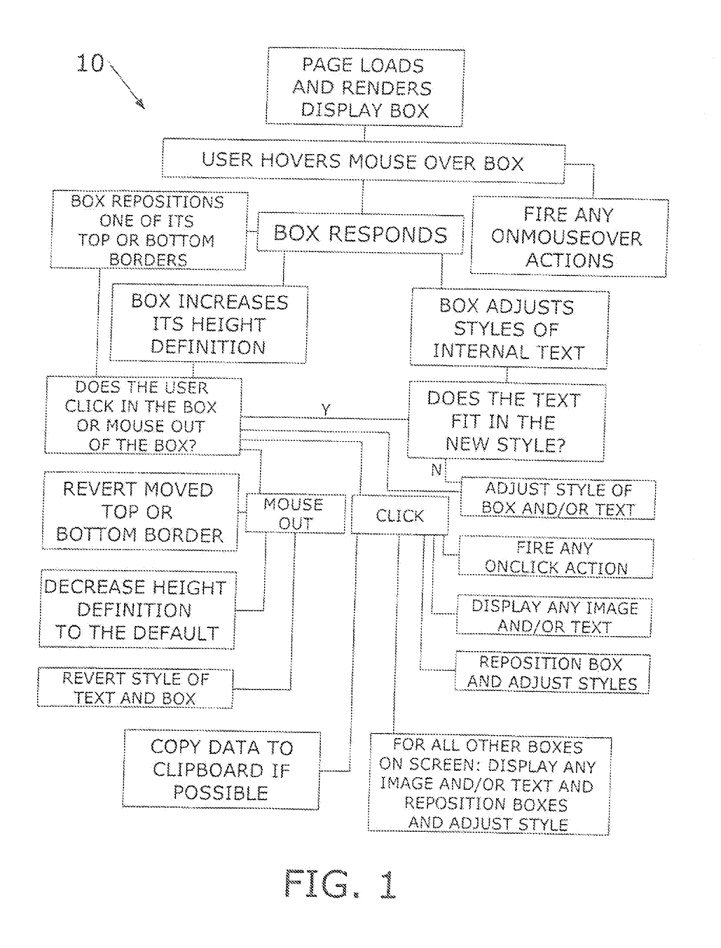

Returning to FIG. 1 when the webpage loads and renders a display box in a first user interface, the user performs an action. For example, the user may move a cursor around the screen, hovering over a particular display box. As illustrated in FIG. 4, when the user's cursor 20 hovers over the display box 14 first response is triggered and a first altered display box 16 is displayed. Additionally, the action of the user is tracked and recorded. If the user stops performing the action the first altered display box 16 reverts to its original state. For example if the user's cursor 20 moves off of the first altered display box 16 without clicking the display box 14 reverts to its original state. If the user performs a second action (e.g. clicks on the first altered display box 16) a second response or second altered display box 18 is displayed and/or an optional second user interface 22 is displayed. By requiring the user to take two actions which trigger two events (i.e. first altered display box and second altered display box) to ultimately view the additional images and/or text (e.g. online coupon code), the user is more invested and may spend more time on the page. Further, the two actions allow for additional tracking of the user which can be used for additional actions, such as opening affiliate windows or setting session cookies.

The display box and interactive functioning thereof is functional with most mobile devices, because it does not utilize Adobe Flash® but instead is written in source code which is cross-browser compliant. This not only allows for better accessibility but also allows the page to load faster than conventional display boxes and within the default mode of all browsers; no separate downloads are necessary to view this content. Because the webpage loads faster the search engine position is also positively affected.

Furthermore, the present method does not require any images, making it ideal for web browsers which target seniors and vision-impaired users, along with allowing more easy-crawled content on the webpage without additional markup which increases search engine visibility. Thus, the display box (computer file) can be an image file, a text file or other file.

The present method should not be limited to online coupon codes. For example, in one alternate embodiment, the present method can be used to display a partial ticket price, such as on a website in which a number of items have been added to a user's cart. Another alternate embodiment could require more user interaction, such as “scratching off” a ticket with a cursor, thereby slowly revealing the underlying image or text. Finally, a modified version could be used in a game application to slowly reveal a map or other image based on user interaction.

The preceding description contains significant detail regarding the novel aspects of the present invention. It should not be construed, however, as limiting the scope of the invention but rather as providing illustrations of the preferred embodiments of the invention. For example, the user is not required to use a computing device having a mouse or a user interface having a cursor. A first action can be performed by the user's finger over a display box thereby creating a first response. The user's finger striking the display box can be a second action, thereby causing a second response. Thus, the scope of the present invention is defined by the claims that follow.

Having described my invention, I claim:

1. A computer-implemented method is a server system for executing a method of providing a user with an interactive webpage defined by a computer readable program code, comprising the steps of:
a. providing said computer readable program code on said server system adapted to execute a set of instructions to display a first user interface;
b. providing a computing device to said user:
i. wherein said computing device communicates with said server system via a communications link; and
ii. wherein said computing device displays said first user interface;
c. providing a first display box on said first user interface, wherein said user can interact with said first user interface;
d. providing a first response when said user exhibits a first action over said first display box; and
e. providing a second response when said user exhibits a second action on said first display box.

2. The computer-implemented method of claim 1, wherein said method further comprises tracking said first action and said second action of said user and storing said first and second action in a first database.

3. The computer-implemented method of claim 1, wherein said computer readable program code is cross browser compliant.

4. The computer-implemented method of claim 1, wherein said first action is said user manipulating a cursor over said first display box.

5. The computer-implemented method of claim 1, wherein said second action is said user clicking on said first display box.

6. The computer implemented method of claim 1, wherein said first action is said user touching said first display box.

7. The computer implemented method of claim 1, wherein said second action is said user striking said first display box.

8. The computer implemented method of claim 1, wherein said display box is a text file.

9. The computer implemented method of claim 1, wherein said display box is an image file.

10. A computer-implemented method in a server system for executing a method of providing a user with interactive webpages, comprising the steps of:
a. providing a set of source code on said server system adapted to execute a webpage;
b. transmitting, from said server system, to a computing device a set of instructions in order to display a first user interface via a communications link;
c. providing a first display box on said first user interface, wherein said user can interact with said first user interface;
d. providing a first response when said user exhibits a first action over said first display box, wherein said first response is altering said display box; and
e. providing a second response when said user exhibits a second action on said first display box.

11. The computer-implemented method of claim 10, wherein said method further comprises tracking said first action and said second action of said user and storing said first and second action in a first database.

12. The computer-implemented method of claim 10, wherein said computer readable program code is cross browser compliant.

13. The computer-implemented method of claim 10, wherein said first action is said user manipulating a cursor over said first display box.

14. The computer-implemented method of claim 10, wherein said second action is said user clicking on said first display box.

15. The computer implemented method of claim 10 wherein said first action is said user touching said first display box.

16. The computer implemented method of claim 10, wherein said second action is said user striking said first display box.

17. The computer implemented method of claim 10, wherein said display box is a text file.

18. The computer implemented method of claim 10, wherein said display box is an image File.

19. The computer implemented method of claim 10, wherein a set of data is generated by said actions of said user.

20. The computer implemented method of claim 19, wherein said set of data is stored on a first database on said server system.
